(19) United States
(12) Patent Application Publication
(10) Pub. No.: US 2004/0056376 A1
(43) Pub. Date: Mar. 25, 2004

(54) Method for preparing precursors for producing monolithic metal oxide aerogels

(75) Inventor: Paul R. Coronado, Livermore, CA (US)

Correspondence Address: Alan H. Thompson, Deputy Lab Counsel for Intellectual Property Law, Lawrence Livermore National Laboratory, P.O. Box 808, L-703, Livermore, CA, 94551, US

(73) Assignee: The Regents of the University of California

(21) Appl. No.: 10/253,141

(22) Filed: Sep. 23, 2002

(51) Int. Cl. C01B 33/12; B29C 65/00

(52) U.S. Cl. 264/42; 423/338

(57) ABSTRACT

A method for preparing precursors for producing high density monolithic aerogels. The method enables fabrication of transparent porous glass monoliths, with the porosity or density controlled by adjusting the ratio of water to monomer. By this adjustment, syneresis is increased or minimized. The method involves either a single step precursor or a two step precursor where a base is added to the single step precursor after hydrolysis has occurred. Monolithic metal oxide aerogels with densities between 0.3 g/cc to 1.5 g/cc have been produced using this method.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

The present invention relates to the fabrication of aerogels, particularly to a method for producing monolithic metal oxide aerogels, and more particularly to a method for preparing precursors for producing monolithic metal oxide aerogels with densities between 0.3 g/cc and 1.5 g/cc which can be as intermediate and high density porous glass having specific refractive indexes.

Aerogels are a special class of open-cell foams derived from the supercritical drying of highly cross-linked inorganic or organic gels. These materials have ultrafine pore sizes of usually less than 1000 Å, continuous porosity, high surface areas of typically 400-1000 m²/g, and a microstructure composed of interconnected colloidal-like particles or polymer chains with characteristic diameters of 100 Å. This microstructure is responsible for the unusual optical, acoustic, thermal, and mechanical properties of aerogels.

Aerogels have been utilized in a wide variety of applications including insulation and fluid separation, such as described in U.S. Pat. No. 6,080,281, issued on Jun. 27, 2000 to Y. A. Attia. Also, transparent monolithic metal oxide aerogels for optical applications have been produced, as exemplified by U.S. Pat. No. 5,958,363, issued on Sep. 28, 1999 to P. R. Coronado.

Porous glass has been developed using the aerogel processing techniques for applications ranging from lightweight optics to nuclear particle detectors and sorption media. Highly porous (i.e. porosity >85%) aerogels typically require special techniques to successfully dry large (i.e. greater than a few centimeters) uncracked pieces. Intermediate porosities (i.e. porosity >10% but <85%) called xerogels, usually require long drying times (e.g. several weeks for pieces >a few centimeters). Also, such xerogels are not very transparent in a particular range of porosities (i.e. <40% to <85%) due to scattering from aggregates within the gel. Thus, there is a need for methods to rapidly process such porous glass (aerogels/xerogels) and also to fabricate lightweight transparent glass having specific refractive indexes.

The present invention provides a solution to this need by providing single step and two step methods for preparing precursors for producing transparent monolithic metal oxide aerogel or glass monoliths with densities between 0.3 g/cc and 1.5 g/cc, for example. By the method of this invention, the porosity or density can be controlled by adjusting the ratio of water to monomer. By this adjustment, syneresis is increased or minimized.

### SUMMARY OF THE INVENTION

It is an object of the present invention to produce transparent porous glass having specific refractive indexes.

A further object of the invention is to provide a method for fabricating transparent porous glass monoliths.

A further objection of the invention is to provide a method for preparing precursors for producing monolithic metal oxide aerogels.

Another object of the invention is to unable the fabrication of transparent monolithic metal oxide aerogels with densities in the range of 0.3 g/cc to 1.5 g/cc.

Another object of the invention is to provide a method for preparing precursor for producing high density monolithic aerogels.

Another object of the invention is to provide a process for making precursors for fabricating transparent porous glass monoliths, wherein to porosity or density can be controlled by adjusting the ratio of water to monomer.

Another object of the invention is to provide a method which involves providing a single step precursor or a two step precursor for producing large (>2 cm) transparent metal oxide aerogel monoliths.

Other objects and advantages of the present invention will become apparent from the following description. Basically, the invention involves preparing precursors for producing monolithic metal oxide aerogels, wherein a single step or two step precursor processing is utilized. The two step precursor technique adds a base to the single step after hydrolysis has occurred. By this method, the porosity or density of the aerogel monolith can be controlled by adjusting the ratio of water to monomer. The monomer may be composed of commercial grades tetraethylorthsilicate (TEOS), tetramethoxysilane (TMOS), purified TMOS, and condensed silica (LH, JP, ETANDTT). Transparent monolithic metal oxide aerogels have been produced using this method, wherein the density is in the range of 0.3 g/cc to 1.5 g/cc. The transparent aerogels made in accordance with the present invention will find use as intermediate density glass for nuclear particle detectors, as well as for strong, lightweight optics for eyeglass lenses, telescopes, etc. This method also enables the rapid process of such porous glass and also to fabricate transparent porous glass having specific refractive indexes.

### DETAILED DESCRIPTION OF THE INVENTION

The present invention is directed to a method for preparing precursors for producing monolithic metal oxide aerogels with densities in the range of about 0.3 g/cc to about 1.5 g/cc. The invention provides a new method to rapidly process porous glass and also to fabricate transparent porous glass having specific refractive indexes. The porosity or density of the transparent porous glass monoliths produced by this invention can be controlled by adjusting the ratio of water to monomer. By this adjustment, syneresis is increased or minimized. The monomer, for example, may be commercial grade tetraethylorthosilicate (TEOS), tetramethoxysilane (TMOS), purified TMOS, and condensed silica (LH, JP, ETANOTT).

The method of this invention may be carried out in a single step precursor process or in a two step precursor process wherein a base is added to the precursor of the single step which expedites the condensation of the monomer. The acid solution can contain about 0.5 to about 1.5 moles of monomer, about 0.5 to about 30 moles of H₂O, and about 1.0×10⁻⁵ to about 0.5 mole of acid. Acid is used to stimulate hydrolysis in the following reaction:

Si(OCH)₄+4H₂O \vec{acid} Si(OH)₄+CH₃OH

The Single Step Precursor:

| | |
|---|---|
| Monomer | 1.0 mole |
| H₂O | 1.0 to 25 moles |
| Acid | 1.0 × 10⁻⁶ to >0.2 mole |

In the single step precursor, the following reactions occur concurrently:

1) MSi(OCH)₄+4MH₂O \vec{acid} MSi(OH)₄+4M(RH₃OH)(Hydrolysis)

2) MSi(OH)₄ \vec{acid} MSiO₂+2 MH₂O (Condensation)

The Two Step Precursor:

The two step precursor is the same as the single step, with the exception that a base is added to the precursor after hydrolysis has occurred. The addition of a base expedites the condensation of the monomer. The base solution contains about 0.050 mole to about 0.15 mole of H₂O, about 0.050 mole to about 0.15 mole of alcohol and about 1×10⁻⁵ to about 5×10⁻⁵ mole of base. The base is mixed in the following solution:

| | | |
|---|---|---|
| H₂O | 0.10 | mole |
| Alcohol | 0.10 | mole |
| Base | 3.0 × 10⁻⁵ | mole |

The alcohol is not mandatory. The water is used to dilute the base and the alcohol is used for consistency of the solution. The amount of the base used is dependent on the length of the working time needed before gelation takes place. The base, for example, may be composed of NH₄OH, NaOH, and Acetic Acid. Formation of the single step or two step precursor may be carried out in a temperature range of 0° to 40° C. and with a pressure of 0.5 to 1.0 atm.

The precursor (single step or two step) is then injected into a sealed mold and allowed to gel before accelerated syneresis is started. The gelation time will depend on the composition of the precursor as well as the temperature, and pressure involved.

For example, the gelation time may be from about 0.7 Hrs. to about 24 Hrs.

The process reduces the cost of making large (6.6 to 52.5 cm) porous glass monoliths because, (1) the process does not require solvent exchange nor additives to the gel to increase the drying rates, (2) only moderate temperatures (25 to 300° C.) and pressures (0 to 1 atm.) are used so relatively inexpensive equipment is needed and, (3) net-shape glass monoliths are possible using the process. The single step and the two step precursor processes have been experimentally verified, and by the use of these processes transparent monolithic metal oxide aerogels have been produced. By adjusting or controlling the porosity or density via the ratio of water to monomer, transparent porous glass monoliths have been produced with densities in the range of 0.3 g/cc to 1.5 g/cc.

By the use of the present invention, intermediate density porous glass can be produced as needed for nuclear particle detectors, for example, as well as strong (high density), lightweight optics are possible for eyeglass lenses, telescopes, etc.

It has thus been shown that the present invention provides new methods (single or two step operations) needed to rapidly process porous glass and also to fabricate transparent porous glass having specific refractive indexes. The porous or density of the glass monoliths can be simply controlled by adjusting the ratio of water to monomer in the precursor formulation. Also, the method can be carried out at temperatures and pressures which eliminate the need for expensive equipment. In addition, net-shape glass monoliths may be produced using this process.

While particular embodiments, operational sequences, materials, and parameters have been described to exemplify and teach the principles of this invention, such are not intended to be limiting. Modifications and changes may become apparent to those skilled in the art; and it is intended that the invention be limited only by the scope of the appended claims.

What is claimed is

1. A method for preparing precursors for producing monolithic metal oxide aerogels, comprising: forming a precursor solution from a monomer and water.

2. The method of claim 1, additionally including adding an acid to the thus formed solution to stimulate hydrolysis.

3. The method of claim 2, additionally including forming the precursors solution from 0.5 to about 1.5 mole monomer, about 0.5 to about 30 mole water, and 1.0×10⁻⁵ to about 0.5 mole acid.

4. The method of claim 1, additionally including adding a base after hydrolysis has occurred to expedite condensation of the monomer.

5. The method of claim 4, additionally including forming the base from at least water and a base material.

6. The method of claim 5, additionally including adding alcohol to the base.

7. The method of claim 6, wherein the base comprising of a mixture of about 0.05 mole to about 0.15 mole water, about 0.05 to about 0.15 mole alcohol, and about 1×10⁻⁵ to about 5×10⁻⁵ mole base material.

8. The method of claim 7, wherein the base material is selected from the group consisting of NH₄OH, NaOH and Acidic Acid.

9. The method of claim 1, additionally including selecting the monomer from the group consisting of tetraethylorthosilicate, tetramethoxy-silane (TMOS), purified TMOS, and condensed silica (LH, JP, ETHANDTT).

10. The method of claim 1, additionally including controlling the density or porosity of the aerogel by adjusting the ration of water to monomer in the precursor solution.

11. In a method for producing transparent porous glass, the improvement comprising: providing specific refractive indexes by adjusting the ratio of water to monomer in the precursor solution.

12. The improvement of claim 11, additionally including forming the precursor solution from a single step or a two step operation.

13. The improvement of claim 12, wherein the single step operation is carried out by adding a quantity of water to a quantity of monomer having a ratio of 0.2-0.6 part water to 1.0 part monomer.

14. The improvement of claim 13, additionally including adding acid to the water/monomer solution in the ratio of 1.0×10⁻⁶ to >0.2 part acid to 1.0 part monomer.

15. The improvement of claim 13, additionally including controlling the porosity or density of the transparent porous glass by adjusting the ratio of water to monomer.

16. The improvement of claim 12, additionally including selecting the monomer from the group consisting of TEOS, TMOS, purified TMOS, and condensed silica (LH, JP, ETANDTT).

17. The method of claim 12, wherein the two step operation is carried out using the single step operation and adding to the water/monomer solution a quantity of base.

18. The method of claim 17, wherein adding the quantity of base is carried out after hydrolysis of the water/monomer solution to expedite condensation of the solution.

19. The method of claim 18, additionally including forming the base from a mixture of at least water and a base material in the ratio of 0.10 part water to 3.0×10⁻⁵ part base material.

20. The method of claim 19, additionally including adding to the mixture of water and a base material a quantity of alcohol is the ratio 0.10 part alcohol to 1.0 part water.

21. The method of claim 20, additionally including selecting the base material from the group consisting of NH₄OH, NaOH and Acidic Acid.

22. In a method for producing monolithic metal oxide aerogels, the improvement comprising: forming the aerogels with densities in the range of 0.3 g/cc to 1.5 g/cc, and wherein the forming operation includes adjusting a ratio of water to monomer in the formation of a precursor solution.

23. The improvement of claim 22, additionally including injecting the precursor solution into a sealed mold, and allowing the solution to gel, thereby forming a net-shape aerogel monolith.
